(19) United States
(12) Patent Application Publication
(10) Pub. No.: US 2024/0330741 A1
(43) Pub. Date: Oct. 3, 2024

(54) Machine Learning Using Robust Stochastic Multi-Armed Bandits with Historical Data

(71) Applicant: International Business Machines Corporation, Armonk, NY (US)

(72) Inventors: Sarah Boufelja-Yacoubi, Richmond (GB); Djallel Bouneffouf, Poughkeepsle, NY (US); Sergiy Zhuk, Dublin (IE)

(21) Appl. No.: 18/128,454

(22) Filed: Mar. 30, 2023

(51) Int. Cl. G06N 20/00

(52) U.S. Cl. CPC G06N 20/00

(57) ABSTRACT

Mechanisms are provided for training a machine learning computer model. The mechanisms execute a first initialization of machine learning training logic based on a determination of propensity scores for each output, of a plurality of predetermined outputs, of a machine learning computer model, the propensity scores being determined from historical data. The mechanisms execute a second initialization of the machine learning training logic by performing a trimmed optimization of the machine learning training logic, based on the historical data, to estimate initial parameters of the machine learning computer model. The resulting initialized machine learning training logic is executed on the machine learning computer model to train the machine learning computer model which is then deployed.

### BACKGROUND

The present application relates generally to an improved data processing apparatus and method and more specifically to an improved computing tool and improved computing tool operations/functionality for automatically dispatching regulated and/or segmented workloads in a cloud computing environment based on previous experience and feedback.

Artificial intelligence (AI) increasingly utilizes machine learning computer models to model various real-world mechanisms, such as biological mechanisms, physics based mechanisms, business and commercial mechanisms, and the like, typically for classification and/or predictive purposes. Such machine learning (ML) computer models include linear regression models, logistic regression, linear discriminant analysis, decision trees, naïve Bayes, K-nearest neighbors, learning vector quantization, support vector machines, random forest, and deep neural networks. While ML computer models provide a good tool for performing such classification and/or predictive operations, the process of generating, training, and testing such ML computer models is a very time consuming and resource consuming intensive process often requiring a large amount of manual effort and requiring a lot of experimentation.

One approach to machine learning involves using techniques for solving the multi-armed bandit (MAB) problem, also sometimes referred to as the K or N-armed bandit problem. In this problem, a fixed number of resources must be allocated between alternative and competing choices in a way that maximizes the expected gain, when the properties of each choice are only partially known at the time of allocation. The MAB problem, and more importantly, the solution, are directed to determining optimum solutions based on a tradeoff between exploration and exploitation.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises executing a first initialization, during an offline learning phase of operation, of machine learning training logic based on a determination of propensity scores for each output, of a plurality of predetermined outputs, of a machine learning computer model. The propensity scores are determined from historical data. The method further comprises executing a second initialization, during the offline learning phase of operation, of the machine learning training logic by performing a trimmed optimization of the machine learning training logic, based on the historical data, to estimate initial parameters of the machine learning computer model. The result of the combination of the first initialization and second initialization is initialized machine learning training logic. The method also comprises executing the initialized machine learning training logic on the machine learning computer model to train the machine learning computer model to generate a trained machine learning computer model. In addition, the method comprises deploying the trained machine learning computer model to a hosting computing system for online phase operation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram illustrating the primary operational components of a balanced Historical Linear Upper Confidence Bound (HLinUCB) machine learning engine in accordance with one illustrative embodiment;

FIG. 2 is an example diagram outlining an Offline Balancing HLinUCB (OB-HLinUCB) algorithm in accordance with one illustrative embodiment;

FIG. 3 is an example diagram of a geometric interpretation of corrupted training data;

FIG. 4 is an example diagram outlining a Robust HLinUCB (R-HLinUCB) algorithm in accordance with one illustrative embodiment;

FIG. 5 is an example diagram outlining a Trimmed Optimization algorithm in accordance with one illustrative embodiment;

FIG. 6 is a flowchart outlining an example operation of an OB-HLinUCB engine in accordance with one illustrative embodiment;

FIG. 7 is a flowchart outlining an example operation for a R-HLinUCB engine in accordance with one illustrative embodiment; and

FIG. 8 is an example diagram of a distributed data processing system environment in which aspects of the illustrative embodiments may be implemented and at least some of the computer code involved in performing the inventive methods may be executed.

### DETAILED DESCRIPTION

Multi-armed bandits (MAB) is an online learning technique where an agent acts by pulling a sequence of arms/actions. Contextual Multi-armed bandits (CMAB) is a type of reinforcement learning algorithm that uses contextual information to make real-time decisions, with a reward being given at each step. The name multi-armed bandits makes reference to the problem being representative of a gambler in a casino faced with a bank of slot machines, where the arms of each slot machine are the titular “arms” of the slot machines, or “bandits”. The problem is one in which the gambler (agent) is attempting to maximize their reward, i.e., monetary payoff, but must divide their time between exploring multiple machines to see which one provides the highest payout, and exploiting the one(s) that are paying the most so far. However, at each step of the process, e.g., a reinforcement learning process, the agent only receives incomplete feedback, e.g., the agent only knows the reward that was obtained from the chosen action, but does not know the reward of the other possible actions. This problem of incomplete feedback is often referred to as the exploration-exploitation dilemma, i.e., the agent needs to exploit the most beneficial known set of actions to get a reward, but also must, at the same time, explore other actions that could possibly provide a better reward in the future.

The main objective of a MAB based online learning mechanism is to choose the sequence of actions which leads to the lowest possible regret (or equivalently, the highest cumulative reward). Though the formalism is simple, MAB captures a wide range of applications and is a quintessential example of the exploration-exploitation dilemma. The most influential exploration strategy underpinning MAB is based on the principle of optimism under uncertainty, i.e., the agent chooses the action with both the highest uncertainty and potential reward. Algorithms differ on how they quantify this uncertainty. For example, Bayesian approaches maintain a full probability distribution over the parameters, whereas Frequentist approaches build a confidence set over the parameters. At every time step, the agent selects the action with the highest upper confidence bound.

As described in Cuzowicz et al., “A Gentle Introduction to Contextual Bandits”, the contextual bandit problem is stated as, in each iteration, an agent is presented with an n-dimensional feature vector that encodes the context of the environment in which the agent is faced with taking an action, i.e., the past and current context of the problem. The agent uses the current context vector, the past context vectors, and the rewards of the actions taken in the past to choose the action to take in the current iteration. After a number of iterations, the agent is able to learn the intrinsic relationships between context vectors and rewards, so that the agent can predict the sequence of actions that maximize the total cumulative reward. The contextual information that the agent can use can be static, such as user demographics, item information, or the like, or dynamic, such as the location, time of day, or any other contextual information that may change over time.

Reinforcement learning mechanisms, which may operate based on MAB, may be used to perform machine learning training of machine learning computer models, e.g., neural networks, deep learning neural networks, and the like. With machine learning training of machine learning computer models, batches of training data are utilized to train the machine learning computer model by processing the training data through the machine learning computer model, computing an error or loss, such as via a stochastic gradient descent, to update the weights of nodes in the machine learning computer model. This is done repeatedly for different batches of the training data, through multiple epochs. The resulting trained machine learning computer model is then tested on testing data, i.e., data not previously used to train the machine learning computer model, to determine if the machine learning computer model is performing as desired, e.g., with regard to accuracy and precision.

The machine learning process can often be modeled as a MAB problem with the trained machine learning computer model representing the solution to the MAB problem as it is trained to provide the correct answer, i.e., the optimum selection of actions given the input to maximize the reward. That is, for machine learning training of a machine learning computer model, such as to perform classifications or predictions, the training may be modeled as a contextual bandits problem in which the targets correspond to the possible actions/arms and a positive reward is attributed to the bandit if the right action is selected, i.e., a right classification or prediction is made by the machine learning computer model.

The description of the illustrative embodiments will focus primarily on the problem of Contextual MAB with Linear payoff and Frequentist uncertainty quantification, e.g., the Linear Upper Confidence Bound (LinUCB) algorithm, as applied to machine learning training of machine learning computer models. LinUCB is a special case of MAB problems, in which the agent receives at every iteration an additional contextual information and estimates the reward of each arm as a linear function of the context and an unknown parameter vector, specific to each arm (i.e., each possible option, or classification, or prediction). The Contextual MAB with Linear payoff and Frequentist uncertainty leverages past experiences to reduce the bandit's regret.

The illustrative embodiments implement a MAB solution that does not start from scratch, but instead is initialized with historical data. In some illustrative embodiments, the mechanisms of the illustrative embodiments improve upon the Historical LinUCB (HLinUCB) and HLin-UCBC with Clustering approach proposed in Bouneffouf et al, “Optimal Exploitation of Clustering and History Information in Multi-Armed Bandit”, 6 CoRR, abs/1906.03979, 2019, available at the website arxiv.org/abs/1906.03979. In accordance with at least one illustrative embodiment, the present invention improves on this approach at least by providing mechanisms to explicitly incorporate constructs that improve the robustness of the bandit algorithm with respect to bias and data corruption. The initialization can be viewed as a data-driven regularization which leverages past experiences, e.g., represented in the historical data, to reduce the bandit's regret.

The illustrative embodiments operate on the recognition that, in many situations, existing observations are available before the start of the bandit algorithm, which could have been gathered through various means, such as previous beta-tests, clinical trials, or the like, for example. Moreover, the illustrative embodiments operate on the recognition that using historical data to initialize the contextual bandits based machine learning mechanisms can decrease the regret, as long as the data is of good quality. However, there may be little to no control over the data generation process of such a dataset, which raises the question of how to efficiently and safely incorporate such datasets into the machine learning process as prior knowledge to train machine learning computer models.

Two major issues can affect the quality of logged data and therefore impede the convergence of machine learning based on the contextual bandits machine learning logic. A first issue is the imbalance of assignments of contexts to arms, which is a special case of the more general question of Offline Policy Evaluation (OPE). OPE is an area in reinforcement learning which deals with the evaluation of a candidate policy using data collected from a different behavioral policy. The key mathematical construct used in OPE is importance sampling. Propensity scores may be used to mitigate potential bias in the online contextual bandits setting. The illustrative embodiments leverage balancing assignments with propensity scores to account for potential bias in the logged data in the HLinUCB setting. It should be appreciated that while the illustrative embodiments will be described with regard to HLinUCB, the illustrative embodiments may also be implemented with other algorithms beyond HLinUCB with these other implementations being based on a separate analysis of the regret bound.

A second issue is corruption of the historical data that is used to perform the initialization. That is, corrupted observations can have severe damaging effects on the regression learning. The mechanisms of the illustrative embodiments apply a robust regression technique in the initialization phase to detect and limit the influence of potentially corrupted samples on the regression learning performed by the machine learning logic to train a machine learning computer model. In some illustrative embodiments, it is assumed for this robust regression technique, that the covariates (contexts) have a non-zero probability of being corrupted. Using historical data to initialize the contextual bandits can decrease the regret, as long as the data is of good quality.

The illustrative embodiments provide an improved computing tool and improved computing tool functionality that operates to mitigate potential pathologies in logged data used in the initialization phase of the Multi-Armed Bandit (MAB) machine learning model training. The illustrative embodiments provide improved computer functionality and logic that operates to mitigate bias and corruption in historical data. The illustrative embodiments provide improved computer functionality and logic with regard to the derivation of regret bounds and the specification of conditions under which improvement in the cumulative reward is observed compared to other MAB mechanisms. In some illustrative embodiments, the improved computer functionality and logic improves upon LinUCB and LinUCB with historical data at least by explicitly incorporating constructs that improve the bandit's robustness against bias and data corruption observed in logged data.

In some illustrative embodiments, the improved computing tool and improved computing tool functionality provides a system, method, and computer program product to address bias selection in contextual multi-armed bandits with historical data. The mechanisms of the illustrative embodiments, during an offline phase, incorporate the historical data, such as in the form of a tuple of (contexts, actions, rewards) or the like, by estimating each “arm's” parameters via a weighted Ridge regression. The weights are inversely proportional to the propensity scores, i.e., 1/P (aₜ=a|x=Xₜ). Historical data can be biased in the sense it is not fully representative of the diversity of {contexts, arms} assignments, which can lead to poor exploration in the online phase of operation. Importance sampling with propensity scores is a technique for dealing with such biased data in observational studies. By weighting the Ridge regression using the inverse of the propensity scores, the bandit's exploration is less biased by frequently observed {context, assignments} tuples in the historical data.

In addition, during the offline phase, a trimmed optimization is performed to estimate an initial set of parameters, using the available, potentially corrupted historical data. Thus, during the offline phase, the illustrative embodiments apply a robust regression technique in the initialization in order to limit the influence of corrupted data samples, yielding a robust contextual multi-armed bandit with historical data.

The mechanisms of the illustrative embodiments, during an online learning phrase, has the bandit observe a new context, choose the best estimated arm which maximizes the upper confidence bound, and receives a reward from the environment. The parameters of the chosen arm are then updated accordingly.

Thus, the illustrative embodiments incorporate historical data in order to decrease the bandit's regret and ensure a faster convergence. However, incorporating the data as is, with safety checks may lead to a poor initialization and in fact a higher regret. The illustrative embodiments ensure that the historical dataset is fully leveraged while implementing the necessary safety mechanisms to protect the CMAB mechanisms from data corruption and selection bias issues.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

As noted above, the illustrative embodiments provide an improved computing tool and improved computing tool functionality that is specifically directed to improving the operation of a contextual multi-armed bandit (CMAB) approach to machine learning training of machine learning computer models. More specifically, the illustrative embodiments provide improved mechanisms for addressing bias and potential corruption in historical data used to initialize the machine learning training of machine learning computer models. The illustrative embodiments provide new computer logic and computer functionality that operate in both offline and online training phases to address these issues.

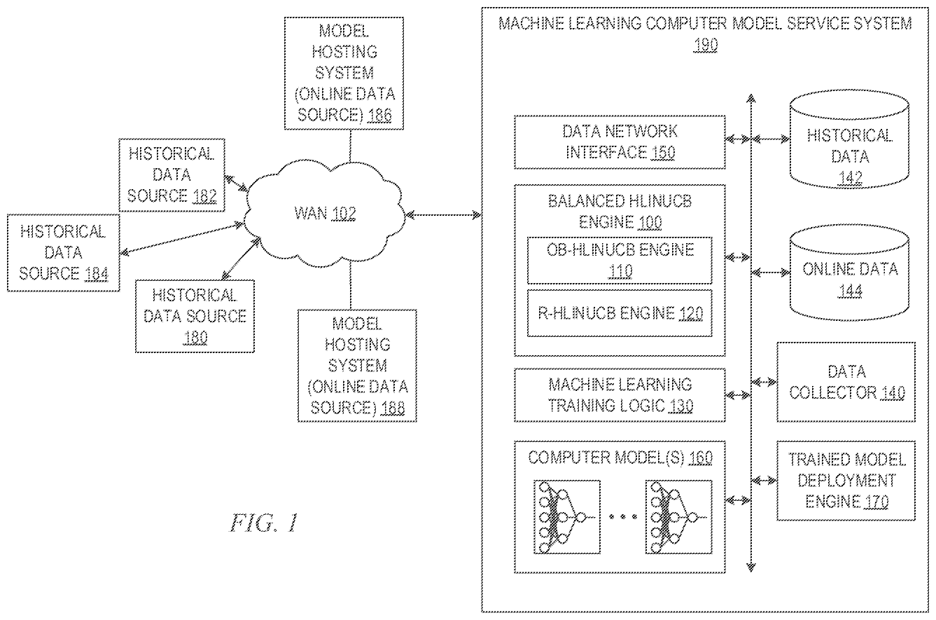

FIG. 1 is an example block diagram illustrating the primary operational components of a balanced HLinUCB machine learning engine in accordance with one illustrative embodiment. The operational components shown in FIG. 1 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though, in some cases, inputs may be provided by human beings, e.g., inputs upon which a machine learning computer model is to operate and perform classifications/predictions, and the resulting output may aid human beings, e.g., the resulting classifications/predictions. The invention is specifically directed to the automatically operating computer components directed to improving the way in which the machine learning computer model may be trained during offline and online phases of operation. These components cannot be practically performed by human beings as a mental process and are not directed to organizing any human activity.

As shown in FIG. 1, the mechanisms of the illustrative embodiments may be integrated into a machine learning computer model service of a system 190 which operates to train one or more machine learning computer models 160 using machine learning training logic 130. In performing the machine learning training of the machine learning computer models 160, the training is performed during both offline and online phases of operation. The offline phase of operation involves training of the machine learning computer models 160 prior to deployment to a runtime environment. This may include training based on historical data 142. The historical data 142 may be compiled and collected by the data collector 140 from various data sources 180-184 via the data network interface 150 and data network(s) 102. It should be appreciated, as noted above, that the quality of this data is not able to be controlled a priori, and thus, the historical data 142 may include bias and corruption which may negatively impact the training of the computer models 160 and cause the resulting trained computer models 160 to perform sub-optimally or even generate incorrect results.

Once trained, the machine learning computer models 160 may be deployed by trained model deployment engine 170 to one or more model hosting systems 186, 188 via the one or more data networks 102, as part of an online phase of operation. During the online phase of operation, actual data from the operation of the computer models at the model hosting systems 186 and 188 may be compiled and collected by the data collector 140 and stored as online data 144 which may be used to update the training of the machine learning computer models 160.

In accordance with the illustrative embodiments, in order to address the potential bias and corruption in the collected data, a balanced HLinUCB engine 100 is provided which includes an OB-HLinUCB engine 110 and a R-HLinUCB engine 120. As noted above, and described in greater detail hereafter, the OB-HLinUCB engine 110, during the offline phase, incorporates the historical data 142 by estimating each “arm's” parameters via a weighted Ridge regression, where the weights are inversely proportional to the propensity scores. In addition, during the offline phase, the OB-HLinUCB engine 110 implements a trimmed optimization to estimate an initial set of parameters, using the available, potentially corrupted historical data. Thus, during the offline phase, the OB-HLinUCB engine 110 applies a robust regression technique in the initialization in order to limit the influence of corrupted data samples, yielding a robust contextual multi-armed bandit with historical data. During the online learning phrase, the R-HLinUCB has the bandit observe a new context, choose the best estimated arm which maximizes the upper confidence bound, and receives a reward from the environment. The parameters of the chosen arm are then updated accordingly.

To appreciate the improved computing tool and improved computing tool functionality provided by the mechanisms of the illustrative embodiments, it is first beneficial to have an understanding of the problem addressed. First, consider the stochastic contextual bandits setting where there is a finite number of arms a (e.g., classifications/predictions generated by the machine learning computer model) that may be pulled (e.g., selected as a final classification/prediction), a∈A, with cardinality K=|A|. Each arm a has a stochastic reward function, modeled as a random variable Rₐ and described by its probability density function (pdf), Pₐ. At every time step, the agent (machine learning computer model, also sometimes referred to as the “bandit”) observes a context, Xₜ∈R^{d}, and chooses an action ar. The modeled environment, i.e., the modeled elements that provide the reward, observes a reward rₜ˜Pₐ and reveals it to the learner, i.e., the machine learning computer model. Herein a* denotes the optimal arm given a context Xₜ, i.e., a*defargmax_{a∈A}E(Rₐ|x=Xₜ).

The context Xₜ may comprise, for example, any historical information of the user, current information about the user and/or environment, or the like. As an example, assume that a user is opening a video streaming service to watch a movie, the context may be the information that the video streaming service has about the user's preferences, the current day of the week, whether the current day is a weekend or workday, a time of day, and the like, i.e., any previous or current information that may be provide insights into the user's probable selections and/or rewards.

In the contextual bandit setting, the context may be defined as a vector of observed features or variables that provide information about the current state or situation, for example. In a more formal definition, the context may be defined as follows. Let X be a d-dimensional vector of observed features or variables, representing the context at a given time step. The context X is drawn from a distribution P(X), which is unknown to the agent. At each time step t, the agent observes the context Xₜ and must choose an action Aₜ from a set of possible actions or “arms”.

The goal of the agent is to minimize its total regret, defined as R(T) [symbol] E[Σₜ₌₁^{T}(r*ₜ−rₜ)], where r*ₜ denotes the optimal reward at time t. It is assumed that the reward is a linear function of the context: E(rₜ|Xₜ)=θₜ^{T}Xₜ, where θₜ is a vector of unknown parameters, i.e., parameters that are to be learned by the machine learning computer model, and Xₜ is the context (again, which may be represented as a vector). Multiplying the unknown parameters with the context results in an expected reward that an arm or action provides. The choice of the arm a at time t depends on the previous assignments and observed rewards {x_{τ}, a_{τ}, r_{τ}}_{τ=1}^{τ=t-1}.

A first assumption of the machine learning model is that ∃θ∈R^{d} such that: rₜ=<θ, Xₜ>+ηₜ where θ are unknown parameters and ηₜ is a sub-Gaussian random variable, e.g., a random noise satisfying a tail condition specified in the following point. A second assumption is that of a sub-Gaussian design, i.e., that the sequence of noise {nₜ}ₜ₌₀^{∞} is R-sub-Gaussian where R≥0 is a fixed constant. Formally, this means ∀λ∈R,

$$E ( {e}^{λ {η}_{t}} \vert {X}_{1 : t} , {n}_{1 : t - 1} ) \leq exp ( \frac{{λ}^{2} {R}^{2}}{2} ) .$$

A third assumption is that there are bounded parameters ∃S_{θ}∈R, ∀a∈A, ∥θₐ∥≤S_{θ}. Natural filtration {Fₜ}ₜ₌₁^{T} of the contextual bandits is defined as the increasing sequence of o-algebras, Fₜ=σ({{xₛ}ₛ₌₁^{t}, {aₛ}ₛ₌₁^{t-1}, {rₛ}ₛ₌₁^{t-1}}). The filtration {Fₜ}ₜ₌₁^{T} contains all the necessary information for predicting the next action.

The ellipsoid confidence set (i.e., an n-dimensional space around a point which is an estimated solution to a problem) over estimated parameters [symbol] ∈A at time t is defined as Cₜ [symbol] {θₐ:∥θₐ− [symbol] ∥_{A}_{ₜ}≤cₜ}, where Ct is the upper confidence bound or the distance between the estimated parameter and the true parameter. For a positive definite matrix A∈R^{d×d}, the weighted norm ∥x∥_{A} for x∈R^{d} is defined by: ∥x∥_{A} [symbol] \sqrt{x^{T}Ax}. If not specified, ∥x∥ denotes the norm-2.

The clipped propensity score of an arm a E A conditional on a context X, is defined by: min (C, P (a=aₜ|Xₜ)), where C is the clipping parameter and P(a=aₜ|Xₜ), where C>0 is a clipping parameter and P(a=aₜ|Xₜ) is the probability of choosing an arm at given a context Xₜ. That is, P is the propensity score for arm at.

The leverage of a data point measures its deviation from its distribution and corresponds to the diagonal elements of the hat matrix: Λ [symbol] X(X^{T}X)⁻¹X^{T}. A data point is said to have influence if it has a substantial effect on the regression coefficients. One measure of influence is Cook's distance, which is a measure of the effect that a data point has on the fitted values of the regression model. Cook's distance is calculated as the change in the estimated regression coefficients when the data point is included or excluded from the model. A data point with a large Cook's distance has a large effect on the estimated regression coefficients and may be considered influential.

In the context of HLinUCB with offline balancing (OB-HLinUCB engine 110), the agent is initialized with historical observation tuples: {x_{τ}, a_{τ}, r_{τ}}_{τ=1}^{τ=T}^{_{H}}, T_{H} being the historical data size, which is used to initialize the HLinUCB algorithm before the start of the online learning phase. It is assumed that the distribution of historical data is the same as what should be expected to be encountered in the online phase, i.e., the distribution of contexts and rewards, i.e., the “environment”, is stationary. The weighted co-variance matrix of the historical data is defined as follows: H=X_{H}^{T}WX_{H}, where W denotes the matrix whose entries are the clipped propensity scores P discussed above. In the online phase, the co-variance matrix is updated as new contexts are observed as follows: Aₜ=H+Σₛ₌₁^{t}X_{S}^{T}X_{S}.

Historical data can be biased in the sense that it does not represent well the diversity of context assignments to arms, which can lead to poor exploration in the online phase of the machine learning. Importance sampling with propensity scores is one technique for dealing with biased data. For example, importance sampling corresponds to the conditional probability of assigning an action or arm given a set of features (context). A stratification based on the propensity scores can actually balance all the observed covariates. In the balanced HLinUCBC 100, the inverse of the propensity scores are used as weights in a weighted Ridge regression. This way, the initial estimates of the regression parameters are less influenced by frequent contexts and assignment pairs in the historical data, and the agent (or “bandit”) can still explore other options in the online learning stage. Balancing may be performed during the online learning phase and offline learning phase, as discussed hereafter, providing a balanced HLinUCBC computing tool.

The balanced HLinUCBC engine 100 of the illustrative embodiments, like other LinUCB and HLinUCB mechanisms, relies on computing an Upper Confidence Bound (UCB) on the rewards of each arm at every time step conditioned on the observed context, then choosing the arm that maximizes this bound. The UCB is the sum of the estimated reward and an uncertainty term. Thus, the UCB naturally handles, therefore, the exploitation (maximal reward) and exploration (maximal uncertainty) trade-off.

The improved computing tool and improved computing tool functionality of the illustrative embodiments improves upon other mechanisms for MAB or CMAB based machine learning of machine learning computer models at least in that the illustrative embodiments provide automated computer functionality that comprises two phases of operation, i.e., an offline phase and an online phase, in which the OB-HLinUCB engine 110 and R-HLinUCB engine 120 operate to address bias and potential corruption in the datasets 142 and/or 144 used to perform the machine learning training, by the machine learning training logic 130, of a machine learning computer model 160. In the offline phase, the illustrative embodiments provide a new logic and computer functionality, referred to herein as the offline balancing HLinUCB, or OB-HLinUCB that handles bias, and a Robust HLinUCB, also referred to as R-HLinUCB, that handles corrupted historical data.

In an offline phase, the OB-HLinUCB engine 110 initializes the CMAB using the historical dataset 142 in the form of {contexts, actions, rewards}. Each arm's parameters are estimated via a weighted Ridge regression, the weights here being inversely proportional to the propensity scores, i.e., 1/P(aₜ=a|x=Xₜ). Propensity scores can be estimated in different ways, such as by using Logistic Regression, but other ways may also be used without departing from the spirit and scope of the present invention. The propensity scores may yield estimates with high variance and thus, a clipping of the propensity scores may be used based on a threshold C to control this variance.

In the online phase, the illustrative embodiments provide a new logic and computer functionality in the OB-HLinUCB engine 110 that observes new contexts, choose the best estimated arm which maximizes the UCB, receives the reward from the environment based on the chosen arm, and updates the parameters of the chosen arm accordingly.

During the offline phase of operation, the R-HLinUCB engine 120 implements logic that uses a trimmed robust optimization to identify and remove potentially corrupted historical data. The trimmed robust optimization operates to estimate the parameters of the regression model using the available, and possibly corrupted, historical data. The trimmed robust optimization fits iteratively a weighted regression to the historical data, starting with randomly initialized weights {wᵢ}. Samples are then reordered based on their increasing residuals, so as to select the first N (upper bound on the pristine dataset size) samples for the next iteration. The algorithm stops when the weights {wᵢ} converge. In the online phase, the R-HLinUCB engine 120 operates a similar logic as in the OB-HLinUCB engine 110.

The combination of the OB-HLinUCB engine 110 and R-HLinUCB engine 120 provide a balanced HLinUCB engine 100, in the form of a robust stochastic multi-armed bandits with historical data computing tool and computing tool functionality, that provides a lower regret and improved performance during machine learning training by machine learning training logic 130 on one or more machine learning computer models 160, than LinUCB or HLinUCB mechanisms, at least by reducing the influence of bias and corruption in the datasets 142, 144 used to perform the machine learning training.

FIG. 2 is an example diagram outlining an Offline Balancing HLinUCB (OB-HLinUCB) algorithm, as may be implemented, for example, in the OB-HLinUCB engine 110 in FIG. 1, in accordance with one illustrative embodiment. It should be appreciated that while the OB-HLinUCB engine 110 has both online and offline phases of operation, the goal of the engine 110 is to deal with the bias and corruption at the offline level and thus, it is referred to as an “Offline Balancing” HLinUCB engine 110. As shown in FIG. 2, a first portion of the algorithm 210 initializes the parameters for the offline and online phases of operation. A second portion of the algorithm 220 outlines an example operation, during an offline phase of machine learning training of a machine learning computer model, such as by the OB-HLinUCB engine 110 in FIG. 1. A third portion of the algorithm 230 outlines an example operation for the online phase of machine learning training of a machine learning computer model, such as by the OB-HLinUCB engine 110 in FIG. 1.

Thus, during the offline phase, the purpose is to debias data by computing the propensity scores and applying them in a weighted linear regression (parametric model where the target is a linear function of explanatory variables, the predictors and the weights are unknown and are to be inferred by fitting data. I is the index matrix (e.g., a square matrix of ones in the diagonal, M is the number of arms/options, and B is a vector that is initially empty (e.g., see lines 6 to 12 of FIG. 2). In the online phase, the learner observes a context, computes a reward estimation for each option and choose the one that maximizes this estimation (e.g., see line 16 of FIG. 2). Upon choosing the arm/option, the learning observes the true reward and uses it to update its regression model (e.g., see line 18 of FIG. 2).

Having discussed the above mechanisms for addressing the bias in historical data used to initialize the machine learning training of a machine learning computer model with CMAB based mechanism, and specifically by providing a n offline balancing HLinUCB engine 110 implementing the OB-HLinUCB algorithm of FIG. 2, it is important to further discuss the issue of corruption that may be present in the historical data. In such a case, both the response variable and the covariates can be subject to corruption. The illustrative embodiments provide a robust HLinUCB engine 120, also referred to as a R-HLinUCB or Adversarial HLinUCB engine, which addresses such potential corruption and minimizes its effects on the machine learning training.

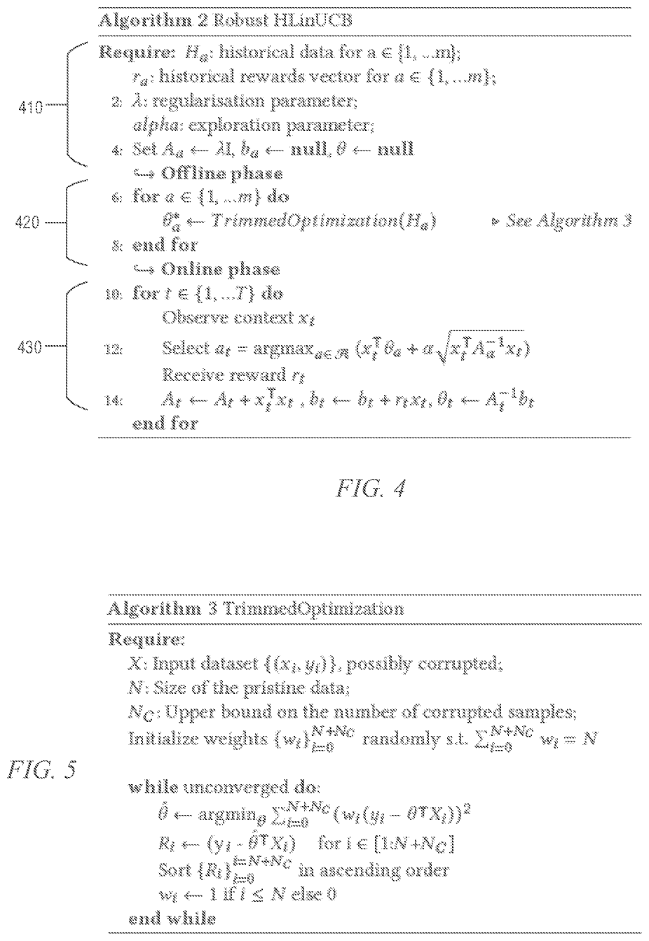

In the illustrative embodiments, it is assumed that some attacker adversarially corrupted the pristine data used for the bandit's initialization. The R-HLinUCB engine 120 and corresponding R-HLinUCB algorithm (see FIG. 4), implements a trimmed robust optimization that identifies and removes potentially corrupted data in a dataset, e.g., historical dataset 142 and/or online dataset 144. The corruption ratio is unknown but the illustrative embodiments assume an upper bound on the corruption. Importantly, the trimmed robust optimization of the R-HLinUCB engine 120 does not rely on any sub-Gaussian noise assumption. However, to derive the regret upper bound, the illustrative embodiments incorporate more structure into the problem of addressing potential corruption by using a statistical model. That is, more formally, the statistical model is:

$$Y = X β + ϵ ,$$

$$Z = X + UW$$

where X∈R^{n×p} is the design matrix of the pristine data, assumed to be sub-Gaussian with parameters (1/nΣₓ, 1/nσₓ²), ϵ∈R^{n×p} is an additive noise term, assumed to be sub-Gaussian with parameters (1/nΣ_{∈}, 1/nσ_{∈}²), Z∈R^{n×p} is the observed corrupted data, U E R^{n×n} is a diagonal Bernoulli matrix, each entry uᵢ is a Bernoulli r.v with parameter π, the probability of corruption, n is a number of samples in the sampled data, and W∈R^{n×p} is a sub-Gaussian corruption matrix with parameters (1/nΣ_{w}, 1/2σ_{w}²), where W is the corruption/noise matrix, sub-additive noise used to corrupt the pristine dataset, each row in U corresponds to the probability of corruption, and N is the number of samples in the pristine historical dataset.

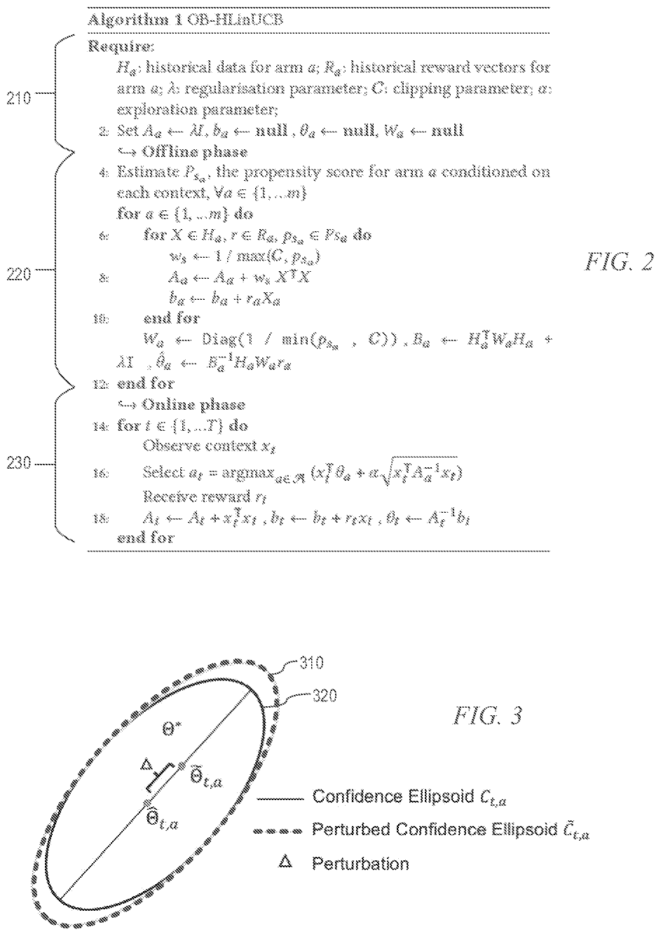

It is assumed that the adversary can corrupt each context with some probability π. Geometrically, the corruption induces a perturbation on the regression parameters, which increases the uncertainty ellipsoid. FIG. 3 provides an example diagram depicting the geometric interpretation of corrupted training data. As shown in FIG. 3, C_{t,a} is the ellipsoid confidence set 320 over the parameters estimated with the pristine data for arm a∈A selected at iteration t. [symbol] is the ellipsoid confidence set 310 over the parameters estimated with the corrupted data for arm a∈A selected at iteration t. The corruption observed in the offline phase induces a perturbation: Δ= [symbol] − [symbol] , where [symbol] are the parameters estimated using the pristine data, and [symbol] are estimated using the corrupted history.

In addition, an important concept for the derivation of the regret bound relies on the statistical notion of influence. The influence of a data point measures the effect it exerts on the regression estimates. The higher the influence, the higher the probability of being corrupted. Influence is related to the concept of leverage but is different. Leverage measures the discrepancy between a given data point xi and the distribution of a feature X. Influence measures the impact each data point has on the machine learning model (e.g., the linear regression), where the higher the influence, the higher the probability the sample is an outlier. For samples coming from the same underlying distribution, the influence is uniformly distributed. The influence allows one to see which data points are impacting the regression the most and allows decision making as to what data points to consider, e.g., if the influence of a data point is high, it suggests that the data point has a large impact on the learned parameters and may be a candidate for data corruption or error. The leverage of a data point, on the other hand, measures how much the data point deviates from the underlying distribution, e.g., if it is high, it may be a corrupt data point.

The R-HLinUCB algorithm (Algorithm 2) in FIG. 4 comprises an initialization portion 410 and then portions 420 and 430 for the offline and online phases of operation, respectively. In the offline stage portion 420, a constrained trimmed optimization is applied, where this constrained trimmed optimization is shown as the TrimmedOptimization algorithm (Algorithm 3) in FIG. 5. The TrimmedOptimization algorithm in FIG. 5 operates to estimate an initial set of parameters, using the available, corrupted historical data and fits a weighted regression to the data iteratively, starting with random weights, which sum up to N, the estimated pristine data size. The samples are then reordered increasingly by their residuals and only the N first data points are kept, for the next iteration. This process is continued until convergence, i.e., when the weights do not change within a given tolerance.

The online phase portion 430 of the R-HLinUCBC algorithm of the R-HlinUCB engine 120 is similar to the one described in the Offline Balanced HLinUCB (OB-HLinUCB) algorithm of the OB-HLinUCB engine 110 (Algorithm 1 of FIG. 2). That is, the agent observes a context, processes the upper confidence bound for each cluster of arms/arm, selects the best cluster/arm, observes the reward and updates the parameters of the selected cluster/arm.

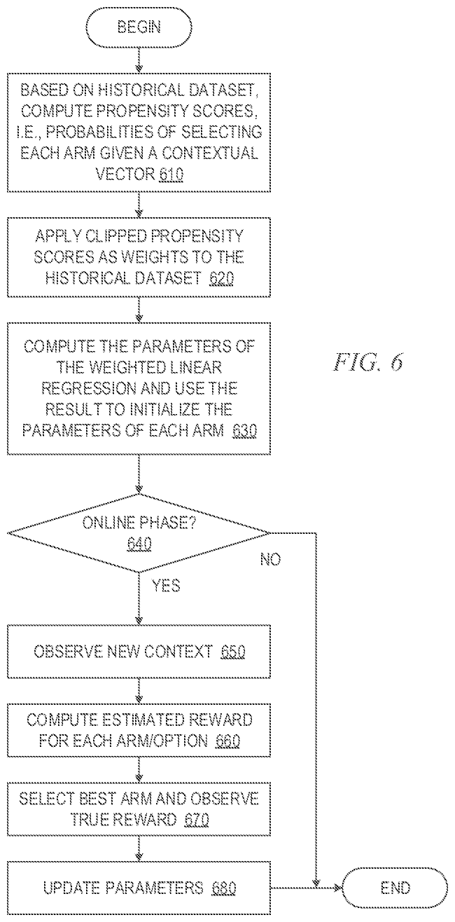

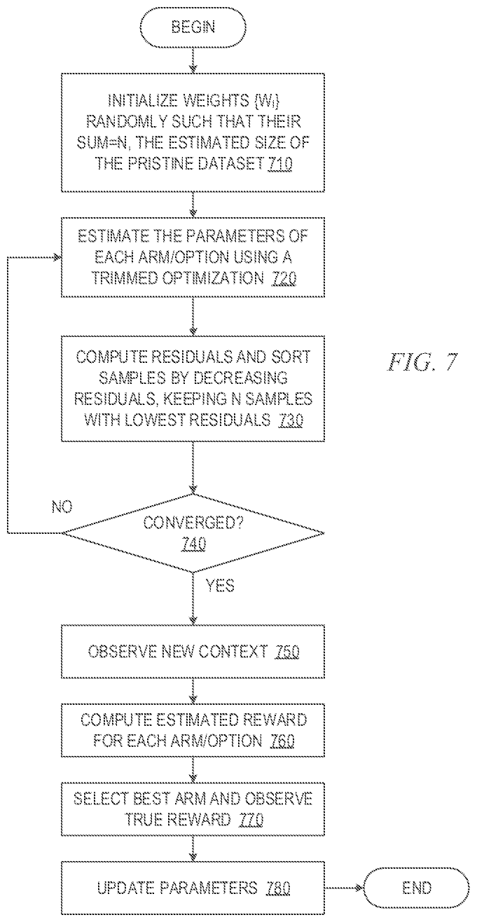

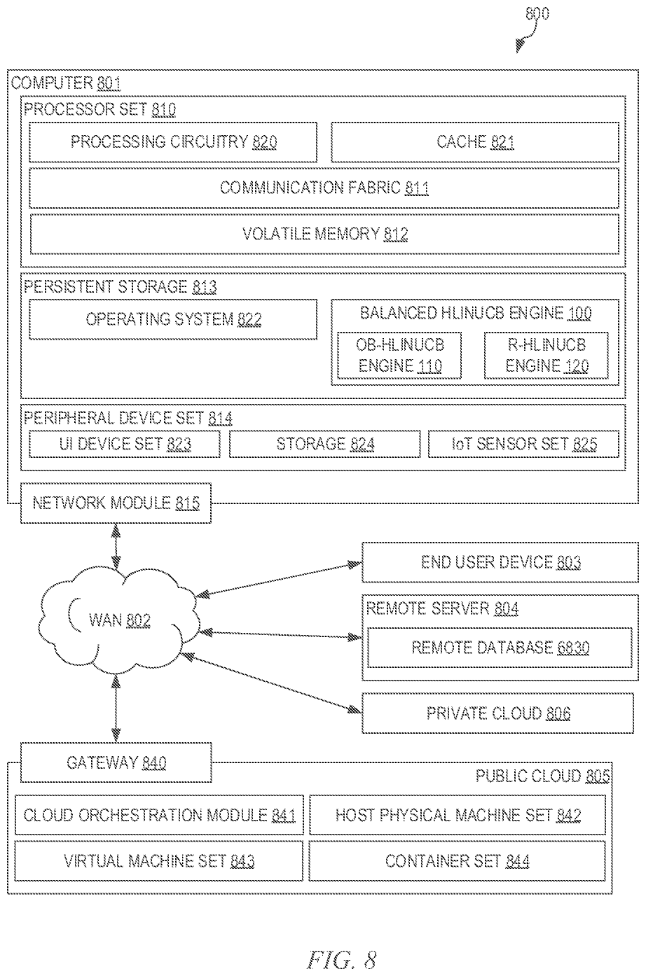

FIGS. 6-7 present flowcharts outlining example operations of elements of the present invention with regard to one or more illustrative embodiments. It should be appreciated that the operations outlined in FIGS. 6-7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 6-7, and may, in some cases, make use of the results generated as a consequence of the operations set forth in FIGS. 6-7, the operations in FIGS. 6-7 themselves are specifically performed by the improved computing tool in an automated manner.

FIG. 6 is a flowchart outlining an example operation of an OB-HLinUCB engine in accordance with one illustrative embodiment. As shown in FIG. 6, during an offline phase of operation, the OB-HLinUCB engine computes the propensity scores, i.e., the probabilities of selecting each arm given a contextual vector, based on a historical dataset (step 610). This operation corresponds to line 4 of Algorithm 1 in section 220 of FIG. 2, in some illustrative embodiments. Clipped propensity scores are then applied as weights to the historical dataset (step 620).

Comparing FIG. 6 to the algorithms of the illustrative embodiments, step 610 correspond to line 4 of Algorithm 1 in section 220 of FIG. 2, in some illustrative embodiments. Clipped propensity scores are then applied as weights to historical dataset (step 620) which corresponds to line 7 of Algorithm 1, i.e. looping over the historical data, historical reward, and propensity scores (line 6), clipping propensity scores (line 7), updating the covariance matrix (line 8), updating the vector b (weighted rewards) line 9, and then end of loop (line 10).

The parameters of the weighted linear regression are computed, and the result is used to initialize the parameters of each arm (step 630). That is, for each action a, the trimmed mean of the rewards received for that action in the historical dataset is computed after removing the highest and lowest p percent of the rewards. The resulting trimmed mean reward is then used as the observed reward for that action in the current context, and the weight vector for that action is updated using the observed reward and context. The upper confidence bounds for each action are then recomputed using the updated weights, and the action with the highest upper confidence bound is selected as the current action.

The OB-HLinUCB engine determines whether to transition to an online phase of operation (step 640). If the operation is not to transition to an online phase, the operation terminates. However, assuming that the OB-HLinUCB engine determines that operation should transition to the online phase, a new context is observed (step 650). The estimated reward for each arm/option is computed (step 660), as discussed above, i.e., for each action a, the trimmed mean of the rewards received for that action in the historical dataset is computed after removing the highest and lowest p percent of the rewards, the resulting trimmed mean reward is then used as the observed reward for that action in the current context, and the weight vector for that action is updated using the observed reward and context. In some illustrative embodiments, this is done in line 16 of Algorithm 1. The best arm/option is then selected by the machine learning computer model, and the true reward is observed (step 670). The parameters of the selected arm/option are then updated (step 680), i.e., the upper confidence bounds for each action are recomputed using the updated weights, and the action with the highest upper confidence bound is selected as the current action (e.g., see line 18 in Algorithm 1, for example). The operation then terminates. While the flowchart shows the operation terminating, it should be appreciated that the online phase operations of FIG. 6 may be repeated during subsequent times of online operation of the machine learning computer model.

FIG. 7 is a flowchart outlining an example operation for a R-HLinUCB engine in accordance with one illustrative embodiment. As shown in FIG. 7, the operation of the R-HLinUCB engine initializes weights {wᵢ} randomly, such that their sum=N, the estimated size of the pristine (uncorrupted) dataset (step 710). The parameters of each arm are estimated using a trimmed optimization (step 720). This may correspond to lines 6-8 of Algorithm 2 in FIG. 4, and the Trimmed Optimization algorithm in FIG. 5 in some illustrative embodiments, for example. The residuals are computed, and the samples sorted by decreasing residuals with N samples with lowest residuals being kept (step 730).

A determination is made by the R-HLinUCB engine as to whether the trimmed optimization has converged (step 740). For example, by monitoring the variance of the trimmed mean estimates over time convergence may be identified. As one example, if the variance of the trimmed mean estimates decreases over time as more data points are added, it suggests that the trimmed mean estimates are becoming more stable and reliable. Conversely, if the variance of the trimmed mean estimates remains high, even as more data points are added, it suggests that the trimmed mean estimates are not converging and may not be reliable. Thus, convergence may be determined by comparing the trimmed mean estimates to the actual rewards obtained from a validation dataset. If the trimmed mean estimates are consistently close to the true expected rewards, it suggests that the trimmed optimization has converged and is providing accurate estimates of the expected rewards. If the trimmed optimization has not converged, the operation returns to step 720. If the trimmed optimization has converged, the operation continues to the online phase of operation in steps 750-780.

Assuming that the R-HLinUCB engine determines that operation should transition to the online phase, a new context is observed, e.g., a new user attempts to utilize the video streaming service (using the previously mentioned example) (step 750). The estimated reward for each arm/option is computed (step 760) using the machine learning model. The best arm/option is then selected by the machine learning computer model, and the true reward is observed (step 770). The parameters of the selected arm/option are then updated in the machine learning model, e.g., the expected reward and weights are updated (step 780).

The machine learning model updates the weights for each action based on an observed reward by adding a term that takes into account the observed reward and the current context, e.g., wₐ=(Aₐ+xₜ*xₜ^{T})⁻¹*(bₐ+xₜ*rₜ) where wₐ is the weight vector for action a, Aₐ is a matrix that represents the sum of outer products of the context vectors associated with action a, bₐ is a vector that represents the sum of the product of the context vectors associated with action a and the observed rewards for those actions, xₜ is the context vector for the current time step t, and rₜ is the observed reward for the action taken at time step t. In other words, the weights for each action are updated by adding a term that takes into account the observed reward and the current context. The matrix (Aₐ+xₜ*xₜ^{T}) represents the sum of outer products of the context vectors associated with action a, up to time t, and the inverse of this matrix is used to update the weights. The vector (bₐ+xₜ*rₜ) represents the sum of the product of the context vectors associated with action a and the observed rewards for those actions, up to time t.

After updating the parameters of the selected arm/option in the machine learning model, the operation then terminates. While the flowchart shows the operation terminating, it should be appreciated that the online phase operations of FIG. 7 may be repeated during subsequent times of online operation of the machine learning computer model.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a balanced HLinUCB engine 200 with OB-HLinUCB engine 210 and R-HLinUCB engine 220. The improved computing tool implements mechanism and functionality, such as balanced HLinUCB engine 200 including an OB-HLinUCB engine 210 and R-HLinUCB engine 220, which cannot be practically performed by human beings either outside of, or with the assistance of, a technical environment, such as a mental process or the like. The improved computing tool provides a practical application of the methodology at least in that the improved computing tool is able to improve contextual multi-armed bandit based machine learning training, especially with regard to historical data used to initialize such machine learning training, by specifically addressing bias and potential corruption of the historical data.

FIG. 8 is an example diagram of a distributed data processing system environment in which aspects of the illustrative embodiments may be implemented and at least some of the computer code involved in performing the inventive methods may be executed. That is, computing environment 800 contains an example of an environment for the execution of at least some of the computer code involved in performing the inventive methods, such as balanced HLinUCB engine 200. In addition to block 200, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 200, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 200 in persistent storage 813.

Communication fabric 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 200 typically includes at least some of the computer code involved in performing the inventive methods.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

As shown in FIG. 8, one or more of the computing devices, e.g., computer 801 or remote server 804, may be specifically configured to implement a balanced HLinUCB engine 200, with components 210 and 220. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 801 or remote server 804, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates improvement in the training of machine learning computer models through machine learning training processes by addressing bias and corruption in the training data, both offline and online, by reducing the influence of such bias and corruption on the machine learning training.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
executing a first initialization, during an offline learning phase of operation, of machine learning training logic based on a determination of propensity scores for each output, of a plurality of predetermined outputs, of a machine learning computer model, wherein the propensity scores are determined from historical data;
executing a second initialization, during the offline learning phase of operation, of the machine learning training logic by performing a trimmed optimization of the machine learning training logic, based on the historical data, to estimate initial parameters of the machine learning computer model, wherein a result of the combination of the first initialization and second initialization is initialized machine learning training logic;
executing the initialized machine learning training logic on the machine learning computer model to train the machine learning computer model to generate a trained machine learning computer model; and
deploying the trained machine learning computer model to a hosting computing system for online phase operation.

2. The method of claim 1, wherein the first initialization of the machine learning training logic is performed via a weighted Ridge regression, where the weights are inversely proportional to the propensity scores.

3. The method of claim 1, wherein the machine learning training logic implements a multi-arm bandit training algorithm in which the machine learning computer model estimates a reward for each of a plurality of possible arms and selects an arm from the plurality of possible arms based on the estimated rewards, wherein each arm is a possible classification or prediction of the machine learning computer model.

4. The method of claim 3, wherein the multi-arm bandit training algorithm is a contextual multi-arm bandit training algorithm with linear payoff and frequentist uncertainty.

5. The method of claim 3, wherein the machine learning computer model receives, at each iteration of machine learning training by the machine learning training logic, additional contextual information and estimates a reward for each possible arm as a linear function of the context and an unknown parameter vector specific to each arm.

6. The method of claim 1, wherein the first initialization is performed by an offline balancing (OB) Historical Linear Upper Confidence Bound (HLinUCB) engine of a machine learning computer model service executing on a remote computing device from the hosting computing system.

7. The method of claim 1, further comprising:
during execution of the trained machine learning computer model in the online phase operation, collecting online data representing an operation of the trained machine learning computer model for a new context; and
updating, during an online learning phase of operation, the training of the trained machine learning computer model based on the collected online data.

8. The method of claim 7, wherein the online data comprises a selection, by the trained machine learning computer model, of an output from the plurality of predetermined outputs given the new context, and a reward received from an environment, and wherein updating the training of the machine learning computer model during the online learning phase of operation comprises modifying at least one parameter of the trained machine learning computer model based on the selection and the reward.

9. The method of claim 8, wherein the output selected by the trained machine learning computer model is an output that maximizes an upper confidence bound.

10. The method of claim 7, wherein updating the training of the machine learning computer model during the online learning phase of operation is performed by a robust (R)-HLinUCB engine of a machine learning computer model service executing on a remote computing device from the hosting computing system.

11. A computer program product comprising a computer readable storage medium having a computer readable program stored therein, wherein the computer readable program, when executed on a computing device, causes the computing device to:
execute a first initialization, during an offline learning phase of operation, of machine learning training logic based on a determination of propensity scores for each output, of a plurality of predetermined outputs, of a machine learning computer model, wherein the propensity scores are determined from historical data;
execute a second initialization, during the offline learning phase of operation, of the machine learning training logic by performing a trimmed optimization of the machine learning training logic, based on the historical data, to estimate initial parameters of the machine learning computer model, wherein a result of the combination of the first initialization and second initialization is initialized machine learning training logic;
execute the initialized machine learning training logic on the machine learning computer model to train the machine learning computer model to generate a trained machine learning computer model; and
deploy the trained machine learning computer model to a hosting computing system for online phase operation.

12. The computer program product of claim 11, wherein the first initialization of the machine learning training logic is performed via a weighted Ridge regression, where the weights are inversely proportional to the propensity scores.

13. The computer program product of claim 11, wherein the machine learning training logic implements a multi-arm bandit training algorithm in which the machine learning computer model estimates a reward for each of a plurality of possible arms and selects an arm from the plurality of possible arms based on the estimated rewards, wherein each arm is a possible classification or prediction of the machine learning computer model.

14. The computer program product of claim 13, wherein the multi-arm bandit training algorithm is a contextual multi-arm bandit training algorithm with linear payoff and frequentist uncertainty.

15. The computer program product of claim 13, wherein the machine learning computer model receives, at each iteration of machine learning training by the machine learning training logic, additional contextual information and estimates a reward for each possible arm as a linear function of the context and an unknown parameter vector specific to each arm.

16. The computer program product of claim 11, wherein the first initialization is performed by an offline balancing (OB) Historical Linear Upper Confidence Bound (HLinUCB) engine of a machine learning computer model service executing on a remote computing device from the hosting computing system.

17. The computer program product of claim 11, further comprising:
during execution of the trained machine learning computer model in the online phase operation, collecting online data representing an operation of the trained machine learning computer model for a new context; and
updating, during an online learning phase of operation, the training of the trained machine learning computer model based on the collected online data.

18. The computer program product of claim 17, wherein the online data comprises a selection, by the trained machine learning computer model, of an output from the plurality of predetermined outputs given the new context, and a reward received from an environment, and wherein updating the training of the machine learning computer model during the online learning phase of operation comprises modifying at least one parameter of the trained machine learning computer model based on the selection and the reward.

19. The computer program product of claim 18, wherein the output selected by the trained machine learning computer model is an output that maximizes an upper confidence bound.

20. An apparatus comprising:
at least one processor; and
at least one memory coupled to the at least one processor, wherein the at least one memory comprises instructions which, when executed by the at least one processor, cause the at least one processor to:
execute a first initialization, during an offline learning phase of operation, of machine learning training logic based on a determination of propensity scores for each output, of a plurality of predetermined outputs, of a machine learning computer model, wherein the propensity scores are determined from historical data;
execute a second initialization, during the offline learning phase of operation, of the machine learning training logic by performing a trimmed optimization of the machine learning training logic, based on the historical data, to estimate initial parameters of the machine learning computer model, wherein a result of the combination of the first initialization and second initialization is initialized machine learning training logic;
execute the initialized machine learning training logic on the machine learning computer model to train the machine learning computer model to generate a trained machine learning computer model; and
deploy the trained machine learning computer model to a hosting computing system for online phase operation.
